(19) United States
(12) Patent Application Publication
(10) Pub. No.: US 2012/0061038 A1
(43) Pub. Date: Mar. 15, 2012

(54) BLIND STRUCTURE

(75) Inventor: Ju-Huai Chen, Changhua County (TW)

(73) Assignee: CHICOLOGY, INC., Ontario, CA (US)

(21) Appl. No.: 12/882,808

(22) Filed: Sep. 15, 2010

(51) Int. Cl. E06B 9/24

(52) U.S. Cl. 160/368.1

(57) ABSTRACT

The present invention relates to a blind structure including a blind body having a batten and a shade; a resilient unit disposed at a first end of the batten, the resilient unit including a pivoting member coupled to the first end of the batten, a fixing member movably coupled to the pivoting member, and a resilient element coupled between the pivoting member and the fixing member; a first end holder coupled to the fixing member; and a second end holder movably coupled to a second end of the batten. The shade is lifted or lowered by exerting a force thereon in conjunction with the resilient unit so as to ensure ease of use and enhance user safety.

### FIELD OF THE INVENTION

The present invention relates to blind structures, and more particularly, to a blind structure with a resilient unit and a shade configured to be lifted or lowered by exerting a force on the shade operating in conjunction with the resilient unit so as to ensure ease of use and enhance user safety.

### BACKGROUND OF THE INVENTION

A conventional blind (such as a Roman blind) comprises an upper beam, an elevating unit, and a shade coupled to the bottom of the upper beam. The elevating unit has a plurality of tractional cords and lifting cords. The shade comprises a plurality of slats. At least a plurality of holes are formed in each of the slats. The holes are lined up and penetrated by the lifting cords in a manner that the lifting cords are fixed to the lowest ones of the holes, respectively. To lift or lower the shade, a user pulls the tractional cords to thereby lift or lower the shade with the lifting cords.

The conventional blind has a drawback. The tractional cords are always found on one side of the shade. Toddlers are likely to put the tractional cords on their necks out of curiosity or during an inadvertent act committed in play. With a tractional cord on the neck, a toddler may end up in strangulation. Hence, tractional cords of the conventional blind pose a serious threat to child safety.

Accordingly, it is imperative to provide a blind structure that features ease of use and enhanced user safety.

### SUMMARY OF THE INVENTION

In view of the aforesaid drawback of the conventional blind structure, the inventor of the present invention believes that the conventional blind structure has room for improvement. Thus, the inventor of the present invention endeavors to improve the conventional blind structure from the inventor's experience of the related industry. Eventually, the inventor puts forth a blind structure that features ease of use and enhanced user safety.

It is a primary objective of the present invention to provide a blind structure with a resilient unit and a shade configured to be lifted or lowered by exerting a force on the shade operating in conjunction with the resilient unit so as to ensure ease of use and enhance user safety.

In order to achieve the above and other objectives, the present invention provides a blind structure including: a blind body having a batten and a shade; a resilient unit disposed at a first end of the batten, the resilient unit including a pivoting member coupled to the first end of the batten, a fixing member movably coupled to the pivoting member, and a resilient element coupled between the pivoting member and the fixing member; a first end holder coupled to the fixing member; and a second end holder movably coupled to a second end of the batten.

In an embodiment of the present invention, a weight member is disposed at another end of the shade, and a tractional member is disposed at the weight member.

In an embodiment of the present invention, the pivoting member comprises a mounting disk, a fixing column, and a communicating tube. The mounting disk is mounted with the resilient element thereon. The fixing column extends from one side of the mounting disk and is coupled to the first end of the batten. The communicating tube is disposed on the other side of the mounting disk, communicates with the fixing column, and is movably coupled to the fixing member. The resilient element is coupled to the communicating tube.

In an embodiment of the present invention, the fixing member comprises a cover, an axle, and a positioning portion. The cover hermetically seals the resilient element and has an inner rim coupled to the resilient element. The axle extends from one side of the cover and is movably coupled to the communicating tube. The positioning portion is disposed on the other side of the cover and coupled to the first end holder.

In an embodiment of the present invention, the resilient element is a constant-force spring.

Accordingly, the present invention provides a blind structure with a resilient unit and a shade configured to be lifted or lowered by exerting a force on the shade operating in conjunction with the resilient unit so as to ensure ease of use and enhance user safety.

### BRIEF DESCRIPTION OF THE DRAWINGS

To enable persons skilled in the art to gain insight into the objectives, features and advantages of the present invention, the present invention is hereunder illustrated with specific embodiments in conjunction with the accompanying drawings, in which:

FIG. 1 is a perspective view of a blind structure of the present invention;

FIG. 2 is an exploded view of the blind structure of the present invention;

FIG. 3 is a schematic view of the working principle of the present invention; and

FIG. 4 is another schematic view of the working principle of the present invention.

### DETAILED DESCRIPTION OF THE PREFERRED EMBODIMENTS

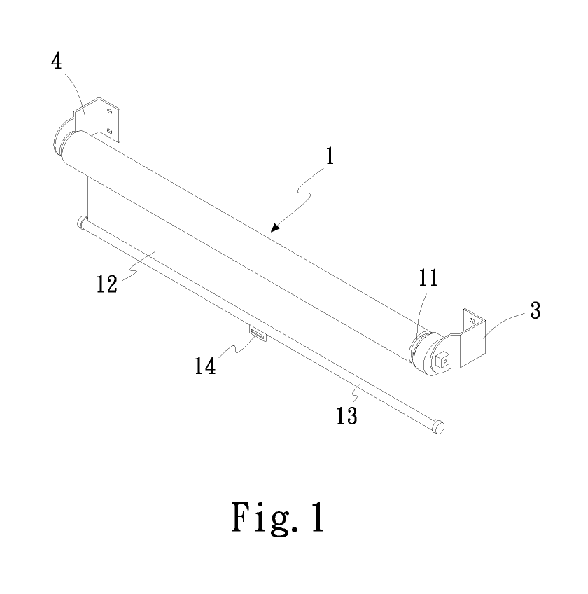

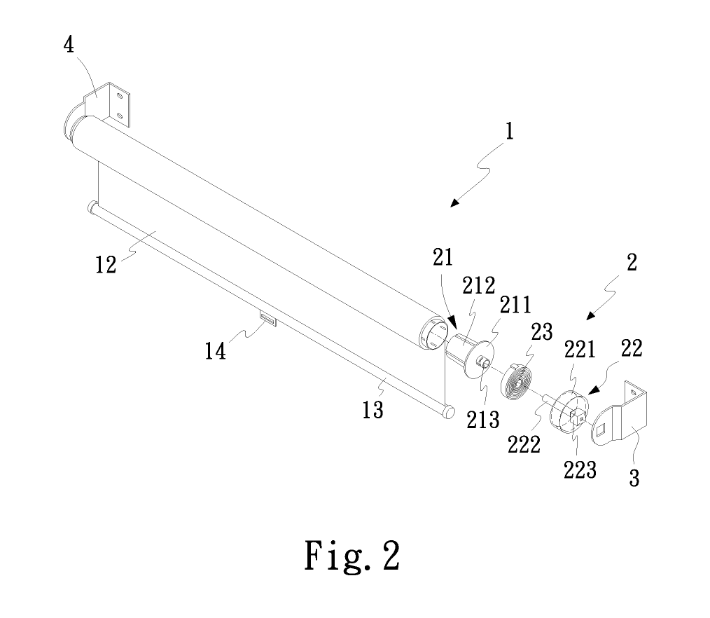

Referring to FIG. 1 and FIG. 2, there are shown a perspective view and an exploded view of a blind structure of the present invention, respectively. As shown in the drawings, a blind structure comprises a blind body 1, a resilient unit 2, a first end holder 3, and a second end holder 4.

The blind body 1 comprises: a batten 11, a shade 12 having an end disposed at the outer edge of the batten 11, a weight member 13 disposed at another end of the shade 12, and a tractional member 14 disposed at the weight member 13.

The resilient unit 2 is disposed at a first end of the batten 11. The resilient unit 2 comprises a pivoting member 21 coupled to the first end of the batten 11, a fixing member 22 movably coupled to the pivoting member 21, and a resilient element 23 coupled between the pivoting member 21 and the fixing member 22. The pivoting member 21 comprises a mounting disk 211, a fixing column 212, and a communicating tube 213. The mounting disk 211 is mounted with the resilient element 23 thereon. The fixing column 212 extends from one side of the mounting disk 211 and is coupled to the first end of the batten 11. The communicating tube 213 is disposed on the other side of the mounting disk 211, communicates with the fixing column 212, and is coupled to the resilient element 23. The fixing member 22 comprises a cover 221, an axle 222, and a positioning portion 223. The cover 221 hermetically seals the resilient element 23 and has an inner rim coupled to the resilient element 23. The axle 222 extends from one side of the cover 221 and is movably coupled to the communicating tube 213. The positioning portion 223 is disposed on the other side of the cover 221. The resilient element 23 is a constant-force spring.

The first end holder 3 is coupled to the positioning portion 223 of the fixing member 22.

The second end holder 4 is movably coupled to the second end of the batten 11.

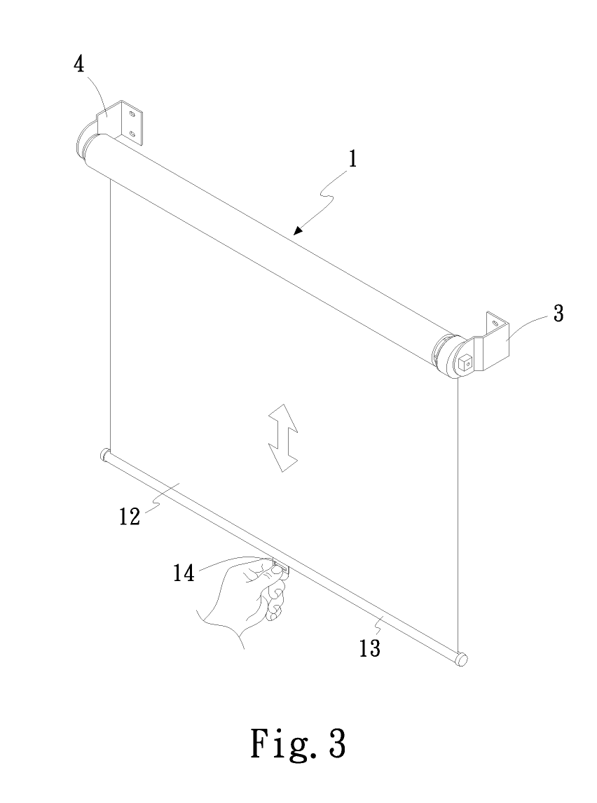

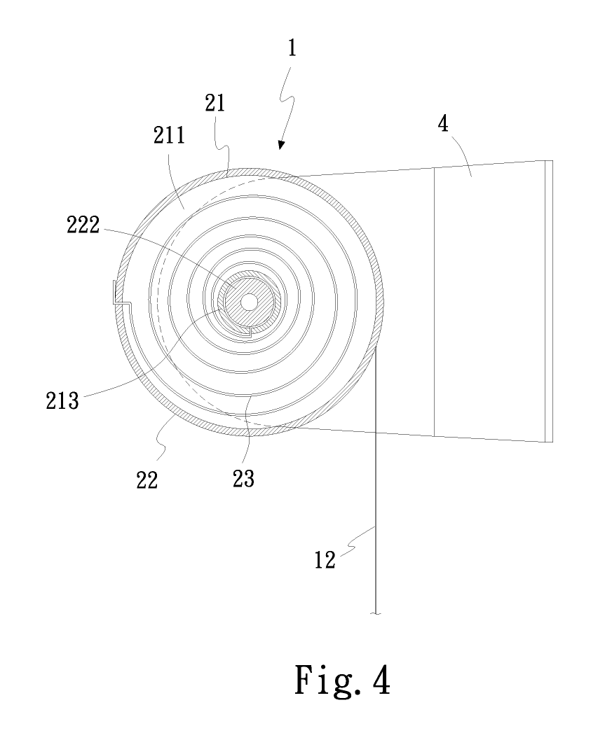

Referring to FIG. 3 and FIG. 4, there are shown schematic views of the working principle of the present invention. As shown in the drawings (and FIGS. 1 and 2 as well), installation of the blind structure of the present invention entails fixing the first end holder 3 and the second end holder 4 to the top of a window frame. To use the blind structure of the present invention, a user applies an external force to the weight member 13 or the tractional member 14 so as to lift or lower the shade 12. The lifting or lowering of the shade 12 drives the batten 11 to rotate; meanwhile, the fixing member 22 of the resilient unit 2 is motionless, thereby allowing the communicating tube 213 to rotate about the axle 222 and thereby drive the resilient element 23 to rotate reversely. Due to its reverse rotation, the resilient element 23 garners sufficient resilience to counterbalance the weight (i.e., the vertical force experienced by the weight member 13 as a result of gravitation) of the weight member 13, thereby allowing the shade 12 to be lowered. To lift the shade 12, the user exerts an upward force on the weight member 13. The upward force counterbalances the weight of the weight member 13 and thereby restores the resilient element 23 to the original state thereof. In so doing, the shade 12 is lifted. Accordingly, the blind structure of the present invention is easy to operate and safe.

Hence, the present invention meets the three requirements of patentability, namely novelty, non-obviousness, and industrial applicability. Regarding novelty and non-obviousness, the present invention discloses applying an external force to a shade to lift or lower the shade and enable the shade to operate in conjunction with a resilient unit with a view to ensuring ease of use and enhancing user safety. Regarding industrial applicability, products derived from the present invention meet market demands fully.

The foregoing preferred embodiments are provided to illustrate and disclose the technical features of the present invention, and are not intended to be restrictive of the scope of the present invention. Hence, all equivalent modifications and replacement of the foregoing embodiments without departing from the spirit embodied in the disclosure of the present invention should fall within the scope of the present invention as set forth in the appended claims.

What is claimed is:

1. A blind structure, comprising:
a blind body comprising a batten and a shade having an end disposed at an outer edge of the batten;
a resilient unit disposed at a first end of the batten, the resilient unit comprising a pivoting member coupled to the first end of the batten, a fixing member movably coupled to the pivoting member, and a resilient element coupled between the pivoting member and the fixing member;
a first end holder coupled to the fixing member of the resilient unit; and
a second end holder movably coupled to a second end of the batten.

2. The blind structure of claim 1, wherein a weight member is disposed at another end of the shade, and a tractional member is disposed at the weight member.

3. The blind structure of claim 1, wherein the pivoting member further comprises a mounting disk, a fixing column, and a communicating tube, the mounting disk being mounted with the resilient element thereon, the fixing column extending from a side of the mounting disk and being coupled to the first end of the batten, so as for the communicating tube to be disposed on another side of the mounting disk, communicate with the fixing column, movably coupled to the fixing member, wherein the resilient element is coupled to the communicating tube.

4. The blind structure of claim 1, wherein the fixing member further comprising a cover, an axle, and a positioning portion, the cover hermetically sealing the resilient element and having an inner rim coupled to the resilient element, the axle extending from a side of the cover and being movably coupled to the communicating tube, and the positioning portion being disposed on another side of the cover and coupled to the first end holder.

5. The blind structure of claim 1, wherein the resilient element is a constant-force spring.
